(19) United States
(12) Patent Application Publication
(10) Pub. No.: US 2012/0269660 A1
(43) Pub. Date: Oct. 25, 2012

(54) ELECTRIC MOTOR AND ELECTRIC SUBMERSIBLE PUMP

(75) Inventors: Weijun Yin, Niskayuna, NY (US); John Raymond Krahn, Schenectady, NY (US)

(73) Assignee: GENERAL ELECTRIC COMPANY, SCHENECTADY, NY (US)

(21) Appl. No.: 13/093,306

(22) Filed: Apr. 25, 2011

(51) Int. Cl. F04B 35/04; H02K 5/132; H02K 9/19

(52) U.S. Cl. 417/410.1; 310/52; 310/87

(57) ABSTRACT

In accordance with one aspect of the present invention, an electric motor is provided that includes a housing, a stator, and a rotor, wherein the stator and the rotor are disposed within the housing. The housing, the stator, and the rotor define an internal volume within the housing, said internal volume configured to receive a dielectric fluid. The stator includes a winding including an electrical conductor disposed within a porous ceramic insulating layer, said porous ceramic insulating layer being in fluid communication with the internal volume. An electric submersible pump system is also provided.

### BACKGROUND

1. Technical Field

The invention relates to motor windings for electric motor. Further, the invention relates to an electric motor configured to operate an electric submersible pump in high temperature environments.

2. Discussion of Related Art

Electrical submersible pump (ESP) systems are used in a wide variety of environments, including wellbore applications for pumping production fluids, such as water or petroleum. The submersible pump system includes, among other components, an induction motor used to power a pump, lifting the production fluids to the surface. In certain applications, for example, down-hole ESP systems for drilling in oil and gas industries and well fluid lifting in an enhanced geothermal system, it may be desirable to operate the ESP motor at temperatures greater than 300° C.

However, high temperatures may lead to undesirable degradation of materials used in current ESP motor designs, in particular, the electrical insulation used in the motor windings. Typically, the motor windings employed in ESP systems for wellbores include organic dielectrics, such as, polyimide, polyetheretherketone, perfluoroalkoxy or polytetrafluoroethylene coatings that typically operate at temperatures lower than 300° C. The dielectric properties of these polymeric insulations tend to degrade over time at such temperatures greater than 300° C.

Thus, there is a need for ESP motor windings that allow continuous operation of the ESP motor in high temperature environment for an extended period of time. Further, there is a need for ESP motor configurations that allow continuous operation of the ESP systems in high temperature environments for an extended period of time.

### BRIEF DESCRIPTION

In accordance with one aspect of the present invention, an electric motor is provided that includes a housing, a stator, and a rotor, wherein the stator and the rotor are disposed within the housing. The housing, the stator, and the rotor define an internal volume within the housing, said internal volume configured to receive a dielectric fluid. The stator includes a winding including an electrical conductor disposed within a porous ceramic insulating layer, said porous ceramic insulating layer being in fluid communication with the internal volume.

In accordance with another aspect of the present invention an electrically submersible pump system is provided. The electrically submersible pump system includes a pump and an electric motor configured to operate the pump. The electric motor includes a housing, a stator, and a rotor, wherein the stator and the rotor are disposed within the housing. The housing, the stator, and the rotor define an internal volume within the housing, said internal volume configured to receive a dielectric fluid. The stator includes a winding including an electrical conductor disposed within a porous ceramic, insulating layer, said porous ceramic insulating layer being in fluid communication with the internal volume.

In accordance with yet another aspect of the present invention, an electric motor is provided. The electric motor includes a housing, a stator, and a rotor, wherein the stator and the rotor are disposed within the housing. The housing, the stator, and the rotor define an internal volume within the housing, said internal volume containing a dielectric fluid. The stator includes a winding including an electrical conductor disposed within a porous ceramic insulating layer, said porous ceramic insulating layer being in fluid communication with the internal volume and the dielectric fluid being in contact with a surface of the electrical conductor.

Other embodiments, aspects, features, and advantages of the invention will become apparent to those of ordinary skill in the art from the following detailed description, the accompanying drawings, and the appended claims.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 is a side view of an electrical submersible pump disposed within a wellbore in accordance with one embodiment of the invention.

FIG. 2 is a side view of an electric motor in accordance with one embodiment of the invention.

FIG. 3 is a cross-sectional view of an electric motor in accordance with one embodiment of the invention.

FIG. 4 is a cross-sectional view of an electric motor in accordance with one embodiment of the invention.

FIG. 5 is a side view of a stator in accordance with one embodiment of the invention.

FIG. 6 is a cross-sectional view of a stator in accordance with one embodiment of the invention.

FIG. 7 is a cross-sectional view of a stator slot in accordance with one embodiment of the invention.

FIG. 8 is a cross-sectional view of a winding in accordance with one embodiment of the invention.

### DETAILED DESCRIPTION

As discussed in detail below, embodiments of the present invention include motor winding configurations for electric motors and electric submersible pump (ESP) systems deployed in a wellbore to pump fluids disposed in a subterranean environment. In certain embodiments, a combination of an electrical conductor and a ceramic insulating layer advantageously allows the winding, the electric motor, and the ESP system to operate in high temperature environments or applications where the system is exposed to high temperature conditions. The ceramic insulating layer advantageously allows for the electrical conductor to be in fluid communication with a dielectric fluid disposed within the internal volume of the motor. The dielectric fluid provides thermal and electrical insulation to the electrical conductor, thus allowing the winding and the electric motor to continuously operate at temperatures greater than about 300° C.

In the following specification and the claims, the singular forms “a”, “an” and “the” include plural referents unless the context clearly dictates otherwise.

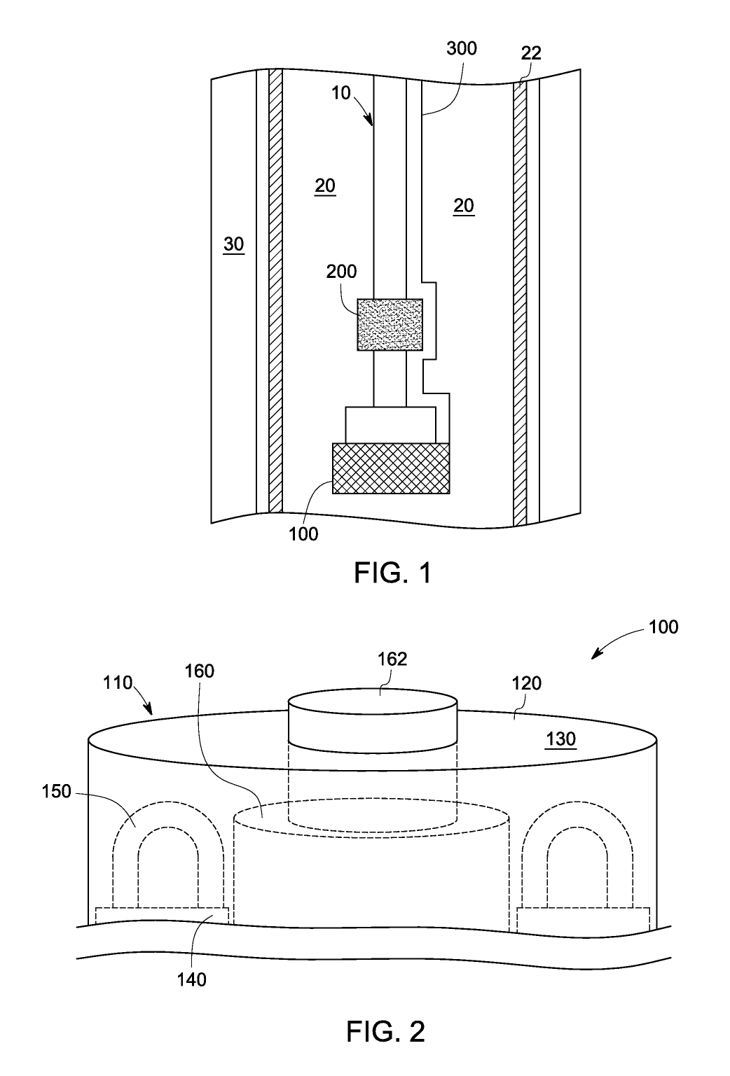

Referring to FIG. 1, an exemplary ESP system 10 is illustrated wherein the ESP system is disposed within a wellbore 20. In one embodiment, the wellbore 20 is formed in a geological formation 30, for example, an oilfield. The wellbore 20 is further lined by a casing 22, as indicated in FIG. 1. In some embodiments, the casing 22 may be further perforated to allow a fluid to be pumped (referred to herein as “production fluid”) to flow into the casing 22 from the geological formation 30 and pumped to the surface of the wellbore 20.

As illustrated in FIG. 1, the ESP system 10 includes an electric submersible pump 200, an electric motor 100 configured to operate the electric submersible pump 200, and an electric cable 300 configured to power the electric motor 100. As noted earlier, the ESP system 10 according to some embodiments of the invention is disposed within a wellbore 20 for continuous operation over an extended period of time. Accordingly, in such embodiments, the ESP system 10 and the components of the ESP system 10 may be subjected to extreme conditions such as high temperatures, high pressures, and exposure to contaminants.

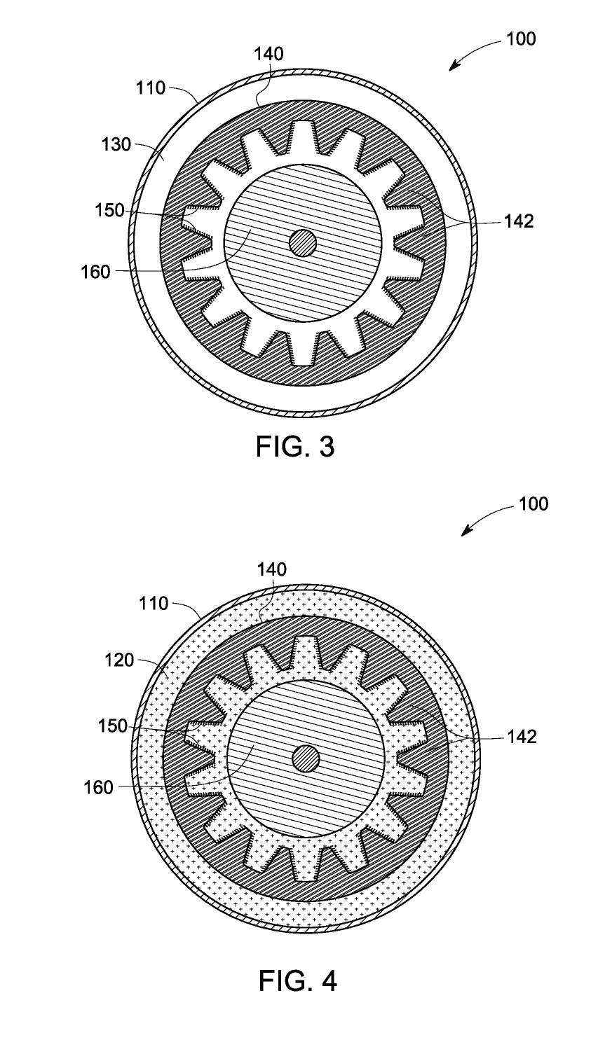

In one embodiment, the present invention provides an electric motor capable of withstanding high temperatures, high pressures, and exposure to contaminants. With reference to FIGS. 2 and 3, an electric motor 100 according to an embodiment of the invention includes a housing 110, a stator 140, and a rotor 160, wherein the stator 140 and the rotor 160 are disposed within the housing 110. In one embodiment, the housing 110, the stator 140, and the rotor 160 define an internal volume 130 within the housing 110, said internal volume 130 configured to receive a dielectric fluid 120, as indicated in FIGS. 2 and 3. In one embodiment, as shown in FIG. 8, the stator 140 further includes a winding 150. In one embodiment, the stator winding 150 includes an electrical conductor 152 disposed within a ceramic insulating layer 156, wherein said ceramic insulating layer 156 is in fluid communication with the internal volume 130.

The term “ceramic” as used herein refers to an inorganic, non-metallic material having high temperature strength, good electro-thermal insulation, and high chemical stability. Further, the term “ceramic” as used herein refers to a crystalline ceramic material or an amorphous ceramic material. In one embodiment, the ceramic insulating layer 156 includes a metal in combination with a non-metal. In one embodiment, the ceramic insulating layer includes an oxide, a nitride, a boride, a carbide, a silicide, a silica, or a sulfide. In one embodiment, the ceramic insulating layer includes a material selected from the group consisting of alumina, silica, aluminum silicate, zirconium oxide, mica, glass and combinations thereof.

In some embodiments, the internal volume 130 is configured such that there is fluid communication between the ceramic insulating layer 156 and the dielectric fluid 120 that the internal volume 130 may contain. The term “fluid communication”, as used herein, means that a volume element within the ceramic insulating layer 156 is in contact with the internal volume 130 of the motor 100. Thus, in some embodiments, where a dielectric fluid 120 is further disposed within the internal volume 130 of the motor 110, the dielectric fluid 120 is in contact with the volume of the ceramic insulating layer 156 as well as a surface of the ceramic insulating layer 156.

In some embodiments, the motor 100 and the components of the motor 100 have a geometry and configuration such that the dielectric fluid 120 when disposed in the internal volume 130 is in fluid communication with the ceramic insulating layer 156.

Further, as shown in FIG. 2, in one embodiment, the motor 100 includes an elongated cylindrical housing 110. In one embodiment, the housing 110 is a pressurized vessel. The motor 110 further includes a rotatable component or a rotor 160. In one embodiment, the rotor 160 includes a drive shaft 162 that extends longitudinally out from the housing 110 and further interconnects to the pump 200, described earlier with reference to FIG. 1.

As noted earlier, the motor 100 further includes a stator 140 disposed within the housing 110. In one embodiment, the stator 140 includes a plurality of metallic laminations 142 disposed within the housing 110. In one embodiment, to form electrical phases within the stator a plurality of windings 150 are wrapped around the laminations 142, as shown in FIGS. 2 and 3. In one embodiment, the laminations 142 include steel laminates.

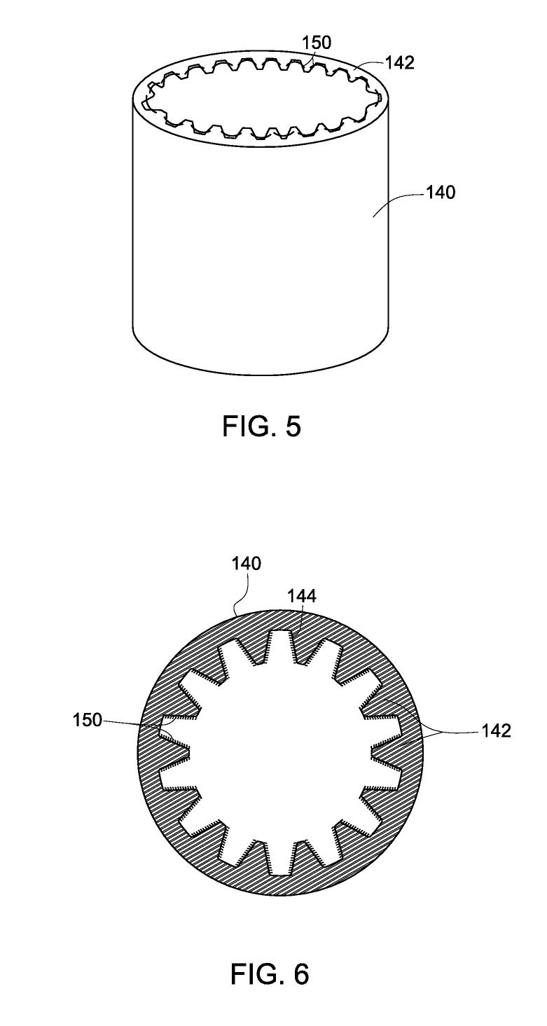

Referring to FIG. 5, a side view of a stator 140 according to an embodiment of the invention is illustrated. The stator 140 includes a plurality of laminations 142 and a plurality of windings 150 are disposed in the laminations 142. FIG. 6 further shows an exemplary top-view of a stator 140, according to an embodiment of the invention. The stator 140 includes a plurality of laminations 142 and a plurality of windings 150 wrapped around the laminations 142. As indicated in FIG. 6, the stator 140 further includes a plurality of stator slots 144 formed by the plurality of laminations 142 and the plurality of windings 150 are disposed in the plurality of stator slots 144. In one embodiment, the plurality of stator slots further include a plurality of slot liners 146. In another embodiment, the plurality of stator slots include a plurality of windings 150 disposed within the stator slots such that the plurality of windings fill the stator slots.

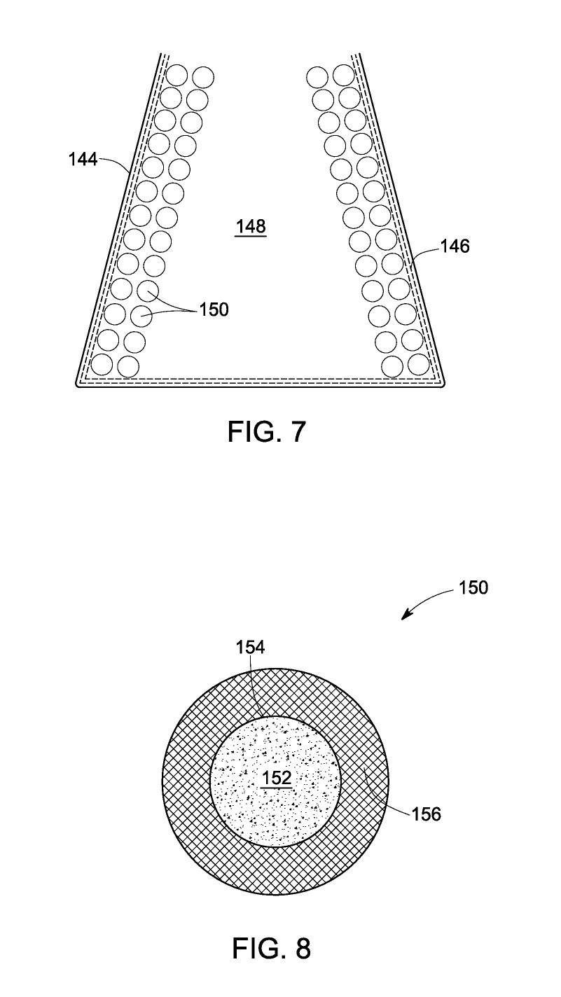

FIG. 7 shows an enlarged view of a stator slot 144 according to an embodiment of the invention. The stator slot 144 includes a slot liner 146 disposed within the stator slot 144. As indicated in FIG. 7, the stator slot further includes a plurality of windings 150 disposed in the stator slot, according to one embodiment of the invention. In some embodiments, the slot liner may function as ground wall insulation. In some embodiments, the slot liner may include mica paper, mica sheet, or a ceramic tape. In one embodiment, the stator slot 144 includes a plurality of windings 150 disposed within the stator slot 144 such that the plurality of windings fill the stator slot 144.

As noted earlier, in some embodiments, the plurality of stator slots 144 in the stator 140 in combination with the rotor 160 define an internal volume 130 within the housing 110, as indicated in FIG. 2. As noted earlier, the internal volume 130 is configured to receive a dielectric fluid 120. Accordingly, with reference to FIG. 7, an internal volume 148 in a stator slot 144 is configured to receive a dielectric fluid 120. Further, as noted earlier, the plurality of windings 150 include an electrical conductor 152 disposed within a porous ceramic insulating layer 156. In one embodiment, the ceramic insulating layer 156 of the plurality of windings 150 is in fluid communication with the internal volume 130 defined by the housing 110, the stator 140, and the rotor 160. In some embodiments, with reference to FIG. 7, the ceramic insulating layer 156 of the plurality of windings 150 is in fluid communication with the internal volume 148 defined by the plurality of stator slots 144.

Referring now to FIG. 8, a cross-sectional view of a winding 150 in accordance with an exemplary embodiment of the invention is shown. The winding 150 includes an electrical conductor 152 disposed within a ceramic insulating layer 156. In one embodiment, the winding is a magnet wire. In one embodiment, the electrical conductor 152 includes copper. In one embodiment, the electrical conductor 152 includes a copper alloy. In one embodiment, the electrical conductor 152 includes a single drawn wire of copper or copper alloys. In another embodiment, the electrical conductor 152 includes a plurality of copper or copper alloy wires twisted together.

In one embodiment, the ceramic insulating layer 156 includes a single layer or a plurality of ceramic insulating layers. In one embodiment, the ceramic insulating layer 156 is disposed around the electrical conductor 152 in the form of a coating, a fabric, a tape, a fiber, a braid, or a combination thereof. In one embodiment, the ceramic insulating layer 156 includes a single layer or multiple layers of thin, high dielectric, high temperature ceramic tape that is wrapped around the electrical conductor 152. In some embodiments, an additional adhesive layer may be disposed between the electrical conductor 152 and the ceramic insulating layer 156 such that the electrical conductor 152 is in fluid communication with the internal volume 156.

As noted earlier, a volume element within the ceramic insulating layer 156 is in contact with the internal volume 130 of the motor 100. In one embodiment, the ceramic insulating layer 156 is capable of imbibing the dielectric fluid 120 such that the dielectric fluid is in contact with a surface of the electrical conductor 152. In some embodiments, the ceramic insulating layer 156 includes interstitial spaces such that the ceramic insulating layer is capable of imbibing the dielectric fluid 120 in the interstitial spaces. In some embodiments, the ceramic insulating layer 156 is a porous layer having a plurality of interconnected pores that allow for fluid communication between the electrical conductor 152 and the internal volume 130.

As noted earlier, a combination of the electrical conductor 152 and the ceramic insulating layer 156 advantageously allows the winding 150, the electric motor 100, and the ESP system 10 to operate in high temperature environments or applications where the system is exposed to high temperature conditions. The ceramic insulating layer 156 advantageously allows for the electrical conductor 152 to be in fluid communication with the internal volume 130 via the ceramic insulating layer 156. In one embodiment, the ceramic insulating layer 156 advantageously allows for the electrical conductor 152 to be in fluid communication with a dielectric fluid disposed within the internal volume 130.

In some embodiments, the geometric relationship between the internal volume 130 and the porous ceramic insulating layer 156 may be such that a dielectric fluid 120 in the internal volume 130 is in contact with the various volume elements within the porous ceramic insulating layer and not only the surface of the ceramic insulating layer 156. In some embodiments, a combination of the ceramic insulating layer 156 and the dielectric fluid 120 disposed or imbibed within the ceramic insulating layer 156 provides electrical and thermal insulation to the electrical conductor 152.

Referring to FIG. 4, in one embodiment, the internal volume 130 as defined by the housing 110, the stator 140, and the rotor 160 contains a dielectric fluid 120. As noted earlier, the dielectric fluid is disposed within the internal volume 130 such that the electrical conductor 152 is in fluid communication with the dielectric fluid 120, as indicated in FIG. 4. Referring again to FIG. 4, the internal volume 148 defined by the stator slot 144 is filled with the dielectric fluid 120. Accordingly, as shown in FIG. 4, the plurality of windings 150 are in fluid communication with the dielectric fluid and so is the electric conductor 152 via the ceramic insulating layer 156. In one embodiment, the dielectric fluid 120 is in contact with a surface 154 of the electrical conductor and configured to provide thermal and electrical insulation to the electrical conductor 152. This is in contrast to a polymeric insulating layer disposed on an electric conductor, where the electrical conductor is separated from the dielectric fluid via the polymeric insulating layer.

Without being bound by any theory, it is believed that the dielectric fluid 120 may provide the desired thermal and electrical insulation to the electrical conductor 152 and thus obviate the need for a separate high temperature electrical insulation, such as, for example, a polymer layer. In one embodiment, the plurality of windings 150, in accordance with certain embodiments of the invention, may be substantially free of a polymeric insulating layer. In one embodiment, the dielectric fluid 120 may provide high temperature electrical insulation to the electric conductor 152 and advantageously allows for continuous operation of the windings 150 and the electric motor 100 at temperatures greater than about 300° C. Continuous operation may refer to a period of operation longer than one hour and up to at least 5 years.

In some embodiments, the dielectric fluid 120 has a boiling point greater than about 300° C. at operating conditions (for example, pressure) and the dielectric fluid may allow for operation of the windings 150 and the electric motor 100 at temperatures greater than about 300° C. In some other embodiments, the dielectric fluid 120 may be subjected to a high pressure to increase the boiling temperature of the dielectric fluid 120 to a temperature greater than about 300° C.

In one embodiment, the dielectric fluid 120 is selected from the group consisting of a silicone oil, a mineral oil, a synthetic ester oil, a natural ester oil such as vegetable oil, a perflorinated polyether, and combinations thereof.

In one embodiment, the electric motor 100 is configured to operate a pump 200 in a borehole 20, as indicated in FIG. 1. In one embodiment, the electric motor 100 is configured to operate an electrical submersible pump 200, as indicated in FIG. 1. In one particular embodiment, the winding 150 is configured to allow operation of the electric motor 100 at a temperature greater than about 300° C. in a borehole 20.

In one embodiment, an ESP system is provided. Referring to FIG. 1, in one embodiment, the ESP system 10 is configured to be installed in a wellbore 20. In one embodiment, the ESP system 10 is configured to be installed in an oilfield 30. In some embodiments, the ESP system 10 may be capable of pumping production fluids from a wellbore 20 or an oilfield 30. The production fluids may include hydrocarbons (oil) and water, for example.

In some embodiments, the ESP system 10 is installed in an oilfield 30 by drilling a hole or a wellbore 20 in a geological formation 30, for example an oilfield. The wellbore 20 maybe vertical, and may be drilled in various directions, for example, upward or horizontal. In one embodiment, the wellbore 20 is cased with a metal tubular structure referred to as a casing 22. In some embodiments, cementing between the casing 22 and the wellbore 20 may also be provided. Once the casing 22 is provided inside the wellbore 20, the casing 22 may be perforated to connect the formation 30 outside of the casing 22 to the inside of the casing 22. In some embodiments, an artificial lift device such as the ESP system 10 of the present invention may be provided to drive downhole well fluids to the surface. The ESP system 10 according to some embodiments of the invention is used in oil production to provide an artificial lift to the oil to be pumped.

An ESP system 10 may include surface components, for example, an oil platform (not shown) and sub-surface components (found in the borehole). In one embodiment, the ESP system 10 further includes surface components such as motor controller surface cables and transformers (not shown). In one embodiment, the sub-surface components may include pump, motor, seals, or cables.

Referring again to FIG. 1, in one embodiment, an ESP system 10 includes sub-surface components such as a pump 200 and an electric motor 100 configured to operate the pump 200. In one embodiment, the electric motor 100 is a submersible two-pole, squirrel cage, induction electric motor. In one embodiment, the electric motor 100 is a permanent magnet motor. The motor size may be designed to lift the desired volume of production fluids. In one embodiment, the pump 200 is a multi-stage unit with the number of stages being determined by the operating requirements. In one embodiment, each stage of the pump 200 includes a driven impeller and a diffuser which directs flow to the next stage of the pump. In some embodiments, the ESP system may further include additional components such as seals, bellows, or springs (not shown).

In one embodiment, as indicated in FIG. 1, the electric motor 100 is further coupled to an electrical power cable 300. In one embodiment, the electrical power cable 300 is coupled to the electric motor 100 by an electrical connector. In some embodiments, the electrical power cable 300 provides the three phase power needed to power the electric motor 100 and may have different configurations and sizes depending on the application. In some embodiments, the electrical power cable 300 is designed to withstand the high-temperature wellbore environment.

Further, as noted earlier, in one embodiment, the electric motor includes a housing 110, a stator 140, and a rotor 160, wherein the stator 140 and the rotor 160 are disposed within the housing, as indicated in FIGS. 2 and 3. As noted earlier, the housing 110, the stator 140, and the rotor 160 define an internal volume 130 within the housing 110, said internal volume 130 containing a dielectric fluid 120, as indicated in FIG. 5. Furthermore, the stator 140 includes a winding 150. The winding 150 includes an electrical conductor 152 disposed within a porous ceramic insulating layer 156, said porous ceramic insulating layer 156 being in fluid communication with the internal volume 130, as indicated in FIG. 8.

In certain embodiments, a combination of an electrical conductor 152 and a ceramic insulating layer 156 advantageously allows the winding 150, the electric motor 100, and the ESP system 10 to operate in high temperature environments or applications where the system is exposed to high temperature conditions. The ceramic insulating layer 156 advantageously allows for the electrical conductor 152 to be in fluid communication with a dielectric fluid 120 disposed within the internal volume 130 of the motor 100. The dielectric fluid 120 provides thermal and electrical insulation to the electrical conductor 152, thus allowing the winding 150, the electric motor 100, and the ESP system 10 to continuously operate at temperatures greater than about 300° C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electric motor, comprising:
(a) a housing;
(b) a stator; and
(c) a rotor;
wherein the stator and the rotor are disposed within the housing,
and wherein the housing, the stator, and the rotor define an internal volume within the housing, said internal volume configured to receive a dielectric fluid,
and wherein the stator comprises a winding comprising an electrical conductor disposed within a ceramic insulating layer, said ceramic insulating layer being in fluid communication with the internal volume.

2. The electric motor as defined in claim 1, further comprising the dielectric fluid disposed within the internal volume.

3. The electric motor as defined in claim 2, wherein the electrical conductor is in fluid communication with the dielectric fluid.

4. The electric motor as defined in claim 2, wherein the dielectric fluid is in contact with a surface of the electrical conductor and configured to provide electrical insulation to the electrical conductor.

5. The electric motor as defined in claim 1, wherein the ceramic insulating layer comprises a porous ceramic material.

6. The electric motor as defined in claim 1, wherein the ceramic insulating layer comprises a material selected from the group consisting of alumina, silica, aluminum silicate, zirconium oxide, mica, and combinations thereof.

7. The electric motor as defined in claim 1, wherein the ceramic insulating layer comprises a coating, fabric, a tape, a fiber, a braid, or a combination thereof.

8. The electric motor as defined in claim 1, wherein the dielectric fluid is selected from the group consisting of a silicone oil, a mineral oil, a synthetic ester oil, a natural ester oil, a perflorinated polyether, and combinations thereof.

9. The electric motor as defined in claim 1, wherein the dielectric fluid has a boiling point greater than about 300° C. at an operating pressure.

10. The electric motor as defined in claim 1, wherein the electrical conductor comprises copper.

11. The electric motor as defined in claim 1, wherein the electric motor is configured to operate a pump in a borehole.

12. The electric motor as defined in claim 1, wherein the motor is configured to operate an electrical submersible pump.

13. The electric motor as defined in claim 1, wherein the winding is configured to allow operation of the electric motor at a temperature greater than about 300° C. in a borehole.

14. The electric motor as defined in claim 1, wherein the stator comprises a plurality of windings, said plurality of windings comprising an electrical conductor disposed within a porous ceramic insulating layer, said porous ceramic insulating layer being in fluid communication with the internal volume.

15. The electric motor as defined in claim 1, wherein the stator comprises:
a plurality of stator slots;
a slot liner disposed in the plurality of stator slots; and
a plurality of windings disposed within the plurality of stator slots, said plurality of windings comprising an electrical conductor disposed within a porous ceramic insulating layer, said porous ceramic insulating layer being in fluid communication with the internal volume.

16. An electrically submersible pump system, comprising:
a pump; and
an electric motor configured to operate the pump, wherein the electric motor comprises:
(a) a housing;
(b) a stator; and
(c) a rotor;
wherein the stator and rotor are disposed within the housing,
and wherein the housing, the stator, and the rotor define an internal volume within the housing, said internal volume configured to receive a dielectric fluid,
and wherein the stator comprises a winding comprising an electrical conductor disposed within a porous ceramic insulating layer, said porous ceramic insulating layer being in fluid communication with the internal volume.

17. The electrically submersible pump system as defined in claim 16, further comprising the dielectric fluid disposed within the internal volume, wherein the electrical conductor is in fluid communication with the dielectric fluid.

18. The electrically submersible pump system as defined in claim 16, wherein the dielectric fluid is selected from the group consisting of a silicone oil, a mineral oil, a synthetic ester oil, a natural ester oil, a perflorinated polyether, and combinations thereof.

19. An electric motor, comprising:
(a) a housing;
(b) a stator; and
(c) a rotor;
wherein the stator and rotor are disposed within the housing,
and wherein the housing, the stator, and the rotor define an internal volume within the housing, said internal volume containing a dielectric fluid,
and wherein the stator comprises a winding comprising an electrical conductor disposed within a porous ceramic insulating layer, said porous ceramic insulating layer being in fluid communication with the internal volume and the dielectric fluid being in contact with a surface of the electrical conductor.

20. The electric motor as defined in claim 19, wherein the winding is configured to operate at a temperature greater than about 300° C.
